(19) United States
(12) Patent Application Publication
(10) Pub. No.: US 2007/0057079 A1
(43) Pub. Date: Mar. 15, 2007

(54) Thermostat capable of displaying downloaded images

(75) Inventors: Mark H. Stark, St. Louis, MO (US); Wallace D. Coffin V, St. Louis, MO (US)

Correspondence Address: HARNESS, DICKEY, & PIERCE, P.L.C, 7700 BONHOMME, STE 400, ST. LOUIS, MO, 63105, US

(73) Assignee: Emerson Electric Co.

(21) Appl. No.: 11/225,533

(22) Filed: Sep. 13, 2005

(51) Int. Cl. G05D 23/00

(52) U.S. Cl. 236/51; 236/94

(57) ABSTRACT

A thermostat is provided that comprises a high resolution display device and is capable of downloading at least one electronic image file for display during time periods in which the user is not interacting with the thermostat. Some embodiments may download two or more images and alternate between the display of each of the at least two downloaded electronic files. The two electronic image files may be successively displayed as a screensaver during time periods when the user is not interacting with the thermostat. Some embodiments of a thermostat may further be adapted to permit the user to save the downloaded electronic files, and to selectively enter names for the downloaded electronic files or delete the electronic files as desired.

### FIELD OF THE INVENTION

The present invention relates generally to thermostats for controlling climate control systems, and more particularly to touch-screen thermostats having high resolution displays.

### BACKGROUND OF THE INVENTION

Digital programmable thermostats are presently available with high resolution display screens, which vary in size depending on surrounding buttons used for operating the thermostat. Touch screen thermostats enable the display size to be increased by incorporating the buttons into the display device. A touch screen thermostat can also provide high resolution display of information relating to the programming and operation of the thermostat. However, the typical touch screen thermostat continuously displays temperature and other heating and cooling system information relating to the space in which the thermostat is installed.

### SUMMARY OF THE INVENTION

Various embodiments of a programmable touch-screen thermostat for controlling a climate control system are disclosed that provide an aesthetic display of an image that is downloaded to the thermostat. According to one aspect of the present invention, one embodiment of a thermostat comprises a display device responsive to a microprocessor for displaying a first screen having at least the sensed temperature of the space, and at least a second screen that is displayed when the user is not interacting with the thermostat wherein the second screen comprises an image file downloaded to the thermostat through the connector.

In another aspect of the invention, a thermostat is provided that comprises a high resolution display device and a microprocessor for controlling the climate control system, wherein the display device is responsive to the microprocessor for intermittently displaying one of a plurality of images during periods when the user is not interacting with the thermostat. The thermostat further comprises a display device responsive to the microprocessor for displaying at least a first screen having at least a.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of one embodiment, shown disassembled, of a thermostat in accordance with the present invention;

FIG. 2 is an illustration of a display image of one embodiment of a thermostat;

Corresponding reference numerals indicate corresponding parts throughout the several views of the drawings.

### DETAILED DESCRIPTION OF THE EMBODIMENTS

The following description of the various embodiments are merely exemplary in nature and are in no way intended to limit the invention, its application, or uses.

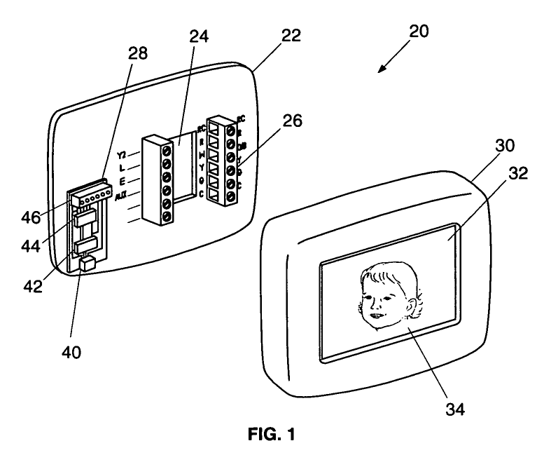

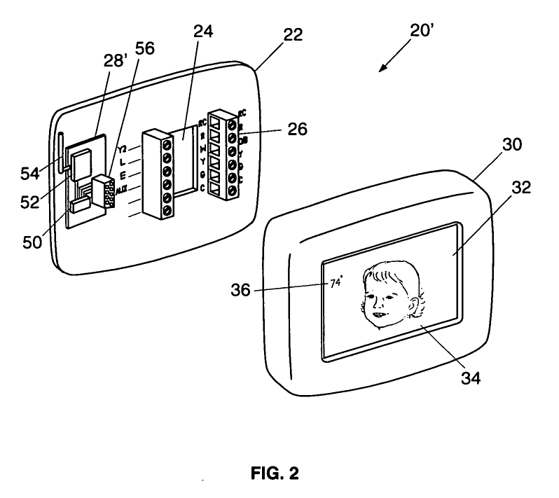

One embodiment of a thermostat 20 according to the principles of the present invention is shown in FIG. 1. The thermostat comprises a sub-base portion 22 having a plurality of connectors for connection to a climate control system, and a thermostat display portion 24 adapted to connect to the sub-base portion 22. The thermostat display portion 24 preferably comprises a display device 26 in communication with a microprocessor for controlling the operation of the thermostat. The display device 26 preferably comprises a touch-sensitive transparent membrane having a plurality of membrane switches (not shown due to the transparent nature of the membrane), where the membrane is adapted to be affixed over the display device 26. The display device 26 is capable of displaying a plurality of icons in locations that correspond to the plurality of membrane switches, such that a displayed user interface icon is associated with a given membrane switch. Thus, the display device 26 is responsive to the microprocessor to display a plurality of icons having associated membrane switches that are in communication with the microprocessor, such that the user may interact with the thermostat 20 to control the climate control system.

In various exemplary embodiments, the thermostat 20 comprises a thermostat display portion 30 adapted to connect to the sub-base portion 22 in a manner that establishes a connection to a climate control system via a plurality of connectors 26, and also a connection to an interface 28 via a connector. The interface 28 establishes communication with an external data source to enable download of at least one electronic file from the external data source. The thermostat 20 comprises a microprocessor for controlling the operation of the thermostat, and for receiving the at least one electronic file downloaded through the interface. The thermostat 20 also comprises a display device 32 responsive to the microprocessor for displaying a representation of at least one electronic file downloaded from the external data source when the user is not interacting with the thermostat 20. The microprocessor generally comprises a program for controlling the operation of the thermostat and climate control system in connection with the plurality of connectors 26. Such thermostat programs for controlling the operation of a climate control system are prevalently used. As such, the program of the microprocessor for controlling the operation of the thermostat and climate control system will not be discussed in detail.

In one first embodiment, a thermostat for controlling a climate control system is provided that comprises a high resolution display device. The display device 26 is preferably an LCD display of a size of at least 2.5 inches by 3.5 inches, and is in communication with the microprocessor of the thermostat. The thermostat comprises a connector 40 for connecting to an external data source. In the first embodiment, the connector 40 is preferably a Universal Serial Bus (USB) port. The USB port is preferably in connection with a Universal Asynchronous Receiver Transmitter (UART) to USB converter chip 42. The UART-to-USB converter is preferably coupled to a UART chip 44 for communication with the thermostat's microprocessor via connector 46.

Referring to FIG. 3, a schematic of one embodiment shows a Universal Serial Bus (USB) port connector 40 for connecting to an external data source. The USB port may be connected to a portable USB memory device, or a USB cable for connecting to a computer, digital camera, PDA, or other external electronic device from which image data files may be downloaded. In the first embodiment, the USB connector 40 is preferably coupled to a UART-to-USB converter such as a FT232BM UART-to-USB converter manufactured by Future Technology Devices International Ltd. (FTDI). The UART-to-USB converter is preferably coupled to a UART chip 44, such as a MAX3100 CPD chip manufactured by Maxim/Dallas Semiconductor. The MAX3100 establishes UART two-way transmission and reception of serial data signals via connector 46 to the thermostat's microprocessor 48. Specifically, the MAX3100 chip receives transmission through pin RX coupled to a USB port in connection with an external data source, and transmits the data through DOUT pin to the microprocessor. The thermostat's microprocessor 48 is preferably a PIC16F84 Microcontroller, which has serial port pins RB4 and RB5 for transmitting and receiving serial data information. The at least one electronic data file is preferably received by the microprocessor, and stored in a non-volatile memory. The memory may be within the microprocessor or a separate EEPROM memory device. Thus, this embodiment provides for connection with an external data source such as a USB memory device, for enabling download of at least one electronic data file of an image to be displayed on the thermostat's display device 32. The thermostat 20 is configured to receive and display jpeg image files due to the nature of their smaller file size, but may alternatively display bitmap image files or other suitable electronic image formats. The thermostat 20 is preferably configured to store at least one electronic image file, and may store a plurality of electronic files depending on the size of the available non-volatile memory in the thermostat.

In various embodiments, a thermostat is provided that comprises a connector adapted to establish connection with an external data source for downloading at least one electronic file from the external data source, and a high resolution display device responsive to a microprocessor for displaying a first screen having at least a sensed temperature value, and for displaying at least a second screen when the user is not interacting with the thermostat. When the user is interacting with the thermostat, such as adjusting the temperature setting, the thermostat displays a first screen showing the sensed temperature of the space and other information relating to the operation of the climate control system. When the user is not interacting with the thermostat, the various embodiments provide a second screen for displaying a representation of one of the at least one electronic file downloaded through the interface connection 40. Thus, various embodiments of a thermostat provide for enabling at least one downloaded electronic file to be displayed during time periods when the user is not interacting with the thermostat.

The housing of the thermostat 20 may be further configured to look similar to a picture frame in appearance, such that the thermostat appears to be a photographic display. The thermostat could be used to display an image of a family member or child as shown in FIG. 1. The thermostat could also be adapted to display a plurality of images of family members in a slide show arrangement. Such a thermostat provides the advantage of a much more aesthetically appealing appearance, compared to conventional thermostats that look more like technical hardware mounted on the wall.

In some embodiments, a thermostat is provided that is capable of downloading at least two electronic files, where the display device alternates between the display of each of the at least two downloaded electronic files. The two electronic files may be downloaded and the images of each file may be successively displayed as a screensaver during time periods when the user is not interacting with the thermostat. Some embodiments of a thermostat may further be adapted to permit the user to save the downloaded electronic files, and to selectively enter names for the downloaded electronic files or delete the electronic files as desired. Such embodiments also permit the user to select at least one downloaded electronic file saved in memory for display on the thermostat's display device.

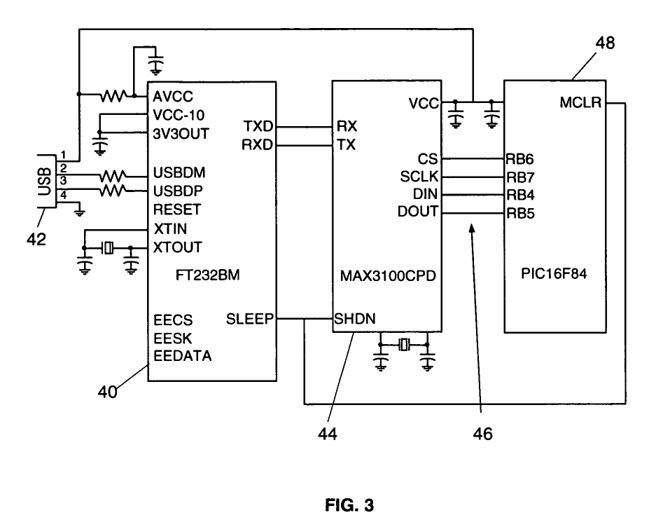

Referring to FIG. 2, a second embodiment of a thermostat 20′ is shown that comprises a wireless interface 28′. In the second embodiment, the interface 28 may be an integrated circuit (IC) comprising a wireless LAN network interface control or Access Point (AP). The interface IC circuit 28 preferably comprises an internet controller chip 50 that is in communication with a Wireless LAN chip 52. The internet controller chip 50 may be an ichip C0710AG/66BI-3 manufactured by ConnectOne, which may be integrated with a wireless LAN chip 52 such as a PRISM 3.0 802.11b wireless LAN chip set. The wireless LAN chip 52 may be in communication with an antenna device 54, that is either trace mounted on the network interface, or externally mounted. The interface IC circuit 28 may preferably communicate via a 9-pin RS-232 connector 56 (or other comparable connector suitable for the application) to a microprocessor that is within the thermostat display portion 30. Thus, the interface IC circuit 28 provides for establishing a wireless connection to a wireless router or WiFi 802.11b broadband internet service that is within a range of 300 meters. The interface IC circuit 28 provides a 48 bit binary MAC number for identifying the thermostat, and provides the Transport Control Protocol and Internet Protocol (TCP/IP) necessary for accessing an internet website, from which at least one electronic file of an image may be downloaded for subsequent display on the display device 32.

Alternatively, the interface IC 28 may be a commercially available AirWave WiFi wireless LAN, AW-ST-CB-EA-RS232 sold by Alpine Technology Ltd, or an Actiontec Mini 802.11B Modem Combo Card manufactured by Actiontec. These interface controls can provide wireless connectivity to a device via a RS232 9-pin interface connector 28.

In the second embodiment, the microprocessor generally comprises a program for controlling the operation of the thermostat and climate control system in connection with the plurality of connectors 26. The microprocessor may be configured to periodically request a connection via the network interface 26 to a server in an external location, or to the internet 110, for accessing a website and downloading an electronic file. Preferably, the user uses suitable input means to enter the desired URL address which contains the images to be downloaded into the thermostat.

Once one or more electronic image files are downloaded, the user may save the downloaded electronic files and selectively enter names for the downloaded electronic files or delete the electronic files as desired. The user may select at least one downloaded electronic file saved in memory for display on the thermostat's display device, or alternate between the display of each of the two or more downloaded electronic files. A plurality of electronic image files may be downloaded and the images of each file may be successively displayed as a screensaver slide show during time periods when the user is not interacting with the thermostat. The thermostat 20 is configured to display jpeg image files due to their smaller memory requirement, but may alternatively display bitmap image files or other suitable electronic image formats. The thermostat 20 is preferably configured to store at least one electronic image file, and may store a plurality of electronic files depending on the size of the available non-volatile memory in the thermostat.

In a third embodiment, a thermostat 20″ is provided that comprises a microcontroller having a serial data input pin that may be coupled directly to an RS-485 connector (or similar connector for peer-to-peer communication) for receiving serial data transmission of an electronic image file through a cable in connection with an external data source. In this embodiment, an inexpensive thermostat is provided that may be connected to a computer, for example, to permit transmission of at least one electronic image file for subsequent display on the thermostat's display device.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A thermostat for controlling a climate control system for a space, the thermostat comprising:
an interface for establishing communication with an external data source to enable download of at least one electronic file from the external data source;
a microprocessor for controlling the operation of the thermostat, wherein the microprocessor receives the at least one electronic file downloaded through the interface; and
a display device responsive to the microprocessor for displaying a representation of at least one electronic file downloaded from the external data source when the user is not interacting with the thermostat.

2. The thermostat of claim 1 wherein the at least one electronic file is displayed during time periods when the user is not interacting with the thermostat.

3. The thermostat of claim 1 wherein the interface is a wireless integrated circuit adapted to receive wireless transmissions from an external source.

4. The thermostat of claim 1 wherein the interface is a Universal Serial Bus (USB) port.

5. The thermostat of claim 4 further comprising a USB-to-Universal Asynchronous Receiver Transmitter (UART) signal converter device for providing serial data communication from the USB port to the microprocessor.

6. The thermostat of claim 1, wherein at least two electronic files are downloaded, and the display device alternates between the display of each of the at least two downloaded electronic files.

7. The thermostat of claim 1 wherein at least two electronic files are downloaded and successively displayed as a screensaver during time periods when the user is not interacting with the thermostat.

8. The thermostat of claim 7 wherein the user may select at least one downloaded electronic file saved in memory for display on the thermostat's display device.

9. The thermostat of claim 8 wherein the user may selectively delete an electronic file that is saved in memory.

10. A thermostat for controlling a climate control system for a space, the thermostat comprising:
a connector adapted to establish connection with an external data source for downloading at least one electronic file from the external data source;
a memory for storing the at least one downloaded electronic file;
a microprocessor for controlling the operation of the thermostat, wherein the microprocessor receives the at least one electronic file downloaded through the connector; and
a high resolution display device responsive to the microprocessor for displaying a representation of at least one electronic file downloaded from the external data source when the user is not interacting with the thermostat.

11. The thermostat of claim 10 wherein the interface is a Universal Serial Bus (USB) port.

12. The thermostat of claim 11 further comprising a USB-to-Universal Asynchronous Receiver Transmitter (UART) signal converter device for providing serial data communication from the USB port to the microprocessor.

13. The thermostat of claim 10, wherein at least two electronic files are downloaded, and the display device alternates between the display of each of the at least two downloaded electronic files.

14. The thermostat of claim 10 wherein at least two electronic files are downloaded and successively displayed as a screensaver during time periods when the user is not interacting with the thermostat.

15. The thermostat of claim 10 wherein the user may select at least one downloaded electronic file saved in memory for display on the thermostat's display device.

16. A thermostat for controlling a climate control system for a space, the thermostat comprising:
a connector adapted to establish connection with an external data source for downloading at least one electronic file from the external data source;
a memory for storing the at least one downloaded electronic file;
a microprocessor for controlling the operation of the thermostat, wherein the microprocessor receives the at least one electronic file downloaded through the connector; and
a high resolution display device responsive to the microprocessor for displaying a first screen having at least a sensed temperature value, and for displaying at least a second screen when the user is not interacting with the thermostat, wherein the second screen comprises a displayed representation of one of the at least one electronic file downloaded through the connector.

17. The thermostat of claim 16 wherein the connector is a Universal Serial Bus (USB) port.

18. The thermostat of claim 17 further comprising a USB-to-Universal Asynchronous Receiver Transmitter (UART) signal converter device for providing serial data communication from the USB port to the microprocessor.

19. The thermostat of claim 18 wherein at least two electronic files are downloaded and successively displayed as a screensaver during time periods when the user is not interacting with the thermostat.

20. The thermostat of claim 18 wherein the user may select at least one downloaded electronic file saved in memory for display on the thermostat's display device.
